(19) United States
(12) Patent Application Publication
(10) Pub. No.: US 2025/0303578 A1
(43) Pub. Date: Oct. 2, 2025

(54) ROBOT CONTROL INFORMATION PROVIDING DEVICE FOR AUTOMATIC TIRE MOUNTING

(71) Applicant: TOSYS Co., Ltd., Incheon (KR)

(72) Inventor: SANG PILL KIM, Incheon (KR)

(21) Appl. No.: 19/073,377

(22) Filed: Mar. 7, 2025

(30) Foreign Application Priority Data
Apr. 2, 2024 (KR) 10-2024-0044842

(51) Int. Cl. B25J 11/00; B25J 13/08; B60C 25/05

(52) U.S. Cl. CPC B25J 11/008; B25J 13/08; B60C 25/0503

(57) ABSTRACT

A robot control information providing device for automatic tire mounting includes a moving member configured to move along the transport direction of a vehicle body, a coupling interlocking unit that couples the moving member with a transport carrier, which transports the vehicle body for tire mounting, thereby allowing the moving member to advance in synchronization with the transport carrier, a return driving unit that provides movement force to the moving member, enabling it to move backward to its original position, and a tracking information providing unit that supplies displacement information of the moving member's forward movement to the control unit of a robot arm for tire mounting.

### CROSS REFERENCE TO RELATED APPLICATIONS AND CLAIM OF PRIORITY

This application claims the benefit under 35 USC § 119 (a) of Korean Patent Application No. 10-2024-0044842 filed on Apr. 2, 2024 in the Korean Intellectual Property Office, the entire disclosure of which is incorporated herein by reference for all purposes.

### BACKGROUND

### 1. Technical Field

The present invention relates to a robot control information providing device for automatic tire mounting.

### 2. Background Art

In general, vehicle production includes numerous assembly processes. Among them, in the tire mounting process, tires are mounted onto the wheel disks of the vehicle body.

Conventionally, tire mounting relied on manual labor by workers. Consequently, this approach led to issues such as increased worker fatigue, delays in production time, higher labor costs, and the risk of mounting defects.

To address these issues, automated methods using robot arm for tire mounting have been introduced.

However, due to various technical challenges, current automation is limited to semi-automated methods, where the vehicle body must be temporarily stopped for tire mounting. Full automation, where tires are mounted while the vehicle body continues moving, has not yet been fully implemented.

### SUMMARY

One or more embodiments of the present invention has been proposed to solve the problems of the related art described above, and an aspect of the present invention is to provide a robot control information providing device for automatic tire mounting that efficiently delivers tracking-related information of the moving vehicle body to the robot arm's control unit. This enables the robot arm to track the moving vehicle body and reliably mount tires onto the wheel disks.

According to an embodiment of the present invention, a robot control information providing device for automatic tire mounting, including a moving member configured to move along the transport direction of a vehicle body; a coupling interlocking unit that couples the moving member with a transport carrier, which transports the vehicle body for tire mounting, thereby allowing the moving member to advance in synchronization with the transport carrier; a return driving unit that provides movement force to the moving member, enabling it to move backward to its original position; and a tracking information providing unit that supplies displacement information of the moving member's forward movement to the control unit of a robot arm for tire mounting.

According to another embodiment of the present invention, a device for tire mounting includes a transport carrier configured to transport a body of a vehicle on which a tire is to be mounted, the robot configured to automatically mount the tire on the vehicle and having the arm and a control unit configured to control the arm, and the robot control information providing device.

The robot control tracking information providing unit may provide displacement information of the moving member's forward movement to the control unit so that the control unit tracks a movement of the vehicle body and controls the arm, based on the provided displacement information

By accurately providing tracking-related information of the vehicle body to the control unit of the robot arm, it becomes possible to implement a fully automated system where tires are mounted while the vehicle body continues moving, without the need for stopping.

By measuring the angle of the front wheel disk and providing its angle information, the robotic system can reliably mount tires regardless of whether the wheel disk is misaligned or tilted.

### BRIEF DESCRIPTION OF THE DRAWINGS

FIG. 1 is a diagram illustrating the robot control information providing device according to an embodiment of the present invention.

FIG. 2 is a side view illustrating the embodiment shown in FIG. 1.

FIGS. 3 to 5 are side view diagrams illustrating the structure of the coupling interlocking unit and its coupling operation in sequential steps.

FIG. 6 is a diagram illustrating the disk angle information providing unit according to an embodiment of the present invention.

FIG. 7 is a diagram illustrating the angle calculation method used by the disk angle information providing unit.

FIG. 8 is a diagram illustrating a vehicle body loaded on a transport carrier entering the home position.

FIG. 9 is a diagram illustrating the coupling of the transport carrier and the moving member.

FIG. 10 is a diagram illustrating the synchronized forward movement of the moving member with the transport carrier.

FIG. 11 is a diagram illustrating the decoupling of the moving member at the return position and its backward movement to the home position.

### DETAILED DESCRIPTION

Hereinafter, an exemplary embodiments of the present invention will be described in detail with reference to the accompanying drawings.

The shape, size, number, and spacing of elements in the attached drawings may be reduced or exaggerated for clarity, and unless otherwise specified, the invention is not limited to the aspects depicted in the drawings.

Additionally, directional terms such as front, rear, left, right, top, and bottom used in the drawings and descriptions are based on the perspective in which the drawings are viewed. Therefore, these terms may vary depending on the observer's viewpoint.

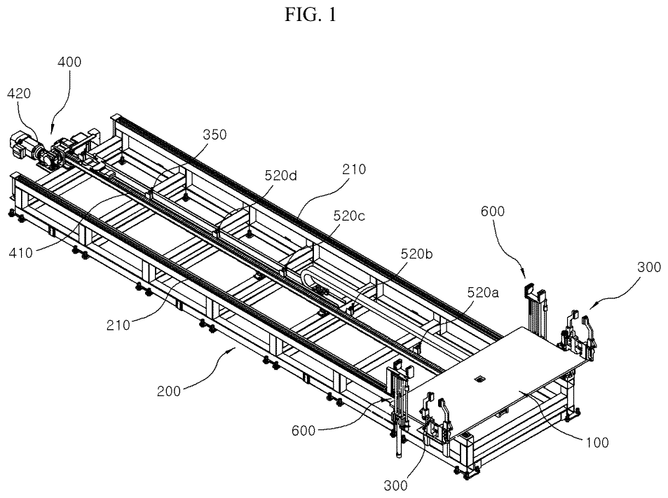

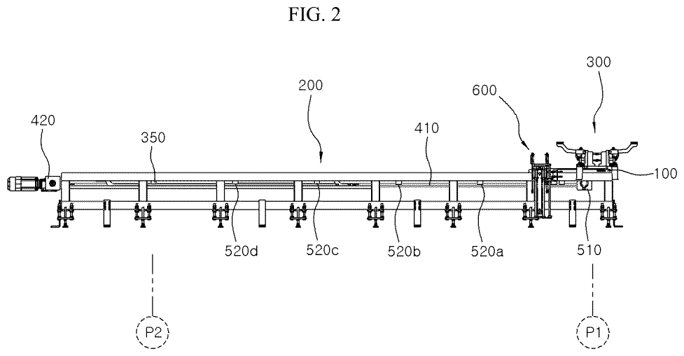

As illustrated in FIGS. 1 to 7, the present invention may include a moving member 100, a coupling interlocking unit 300, a return driving unit 400, a tracking information providing unit, and a disk angle information providing unit 600.

The moving member 100 may be provided on the lower side of a transport carrier C that transports a vehicle body V intended for tire mounting.

Here, the transport carrier C is a structure that conveys the vehicle body V for tire mounting. The vehicle body V is supported and loaded on the hanger arm (h) of the transport carrier C and moves as the transport carrier C advances.

The moving member 100 may be configured to reciprocate forward and backward along the transport direction of the vehicle body V loaded on the transport carrier C.

For this purpose, for example, a base frame 200 may be fixedly installed on the ground. The base frame 200 is a fixed structure that supports the moving member 100 so that it can reciprocate forward and backward along the transport direction of the vehicle body V.

On both left and right sides of the base frame 200, guide rails 210 may be provided to extend parallel in the front-rear direction, guiding the forward and backward movement of the moving member 100.

The moving member 100 reciprocates between a home position P1 at the rear side and a return position P2 at the front side, viewed in the transport direction.

At the home position P1, the moving member 100 is coupled with the transport carrier C via a coupling interlocking unit 300 described later, and it moves forward in synchronization with the transport carrier C. At the return position P2, the coupling is released, and the moving member 100 is independently moved backward by the return driving unit 400, described later, to return to the home position P1.

In other words, the moving member 100 moves forward at the same speed as the transport carrier C by being coupled to it and driven by its transport force. Separately, it moves backward by the driving force of the return driving unit 400, independent of the transport carrier C.

The coupling interlocking unit 300 is a component that allows the moving member 100 to couple with the transport carrier C and interlock with it.

As illustrated in FIG. 1, the coupling interlocking unit 300 may be configured as a pair and fixedly provided at both left and right ends of the moving member 100.

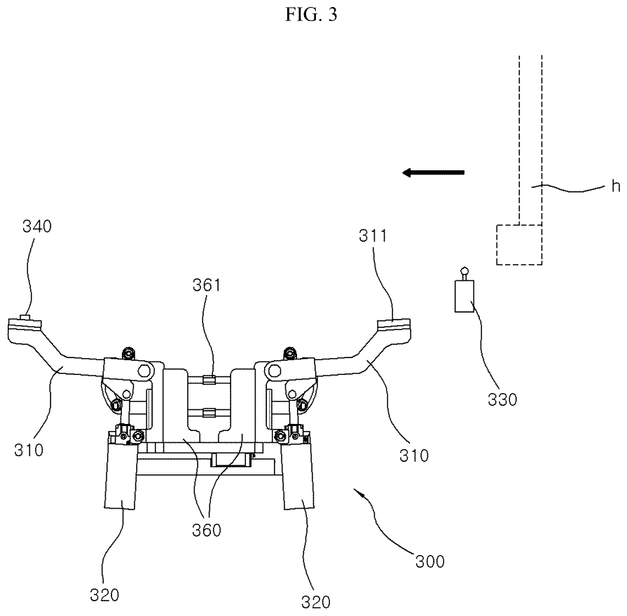

As shown in FIG. 3, the coupling interlocking unit 300 may include, for example, a clamper 310, a clamping cylinder 320, first and second interlocking switches 330, 340, and an interlock release switch 350.

The clamper 310 may include a pair of front and rear clampers that can rotate to approach or separate from each other.

When the pair of clampers 310 rotate upward to approach each other, they are positioned in the path of the hanger arm (h), holding it and coupling the moving member 100 with the transport carrier C.

Conversely, when they rotate downward to separate, they release the hanger arm (h) and move out of its path, thereby disengaging the moving member 100 from the transport carrier C.

Each clamper 310 may have an elastic holder 311 at its tip to provide firm contact with the hanger arm (h).

The clamping cylinder 320 applies rotational force to each of the pair of clampers 310.

Accordingly, the clamping cylinder 320 may also be provided in a pair corresponding to the front and rear clampers 310.

The first and second interlocking switches 330, 340 provide operation signals for coupling, while the interlock release switch 350 provides an operation signal for release.

The first interlocking switch 330 may be positioned at a predetermined location behind the pair of clampers 310 at the home position P1.

The second interlocking switch 340 may be located at the tip of the front clamper 310, specifically at the elastic holder 311 of the front clamper 310.

The interlock release switch 350 may be located at the return position P2.

The first and second interlocking switches 330, 340 sequentially contact the hanger arm (h) of the transport carrier C, transmitting operation signals to the pair of clamping cylinders 320 for rotation.

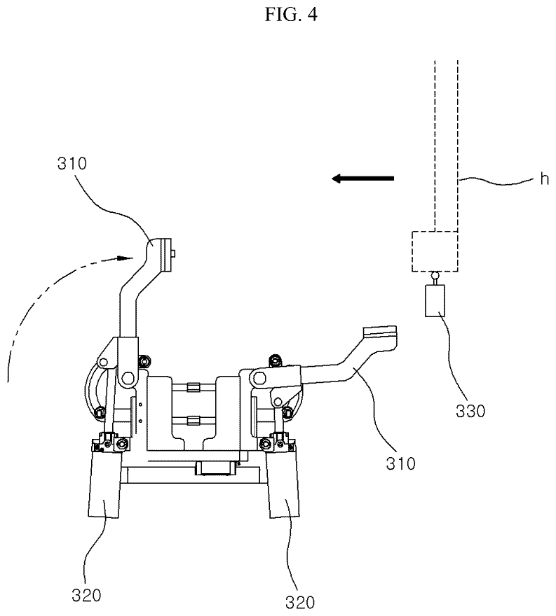

That is, when the transport carrier C carrying the vehicle body V enters the home position P1, as illustrated in FIG. 4, the hanger arm (h) first contacts the first interlocking switch 330.

Following this contact signal, the front clamper 310 rotates upward and is positioned in the movement path of the hanger arm (h).

As the transport carrier C continues to move forward, the hanger arm (h) comes into contact with the front clamper 310, making close contact and activating the second interlocking switch 340.

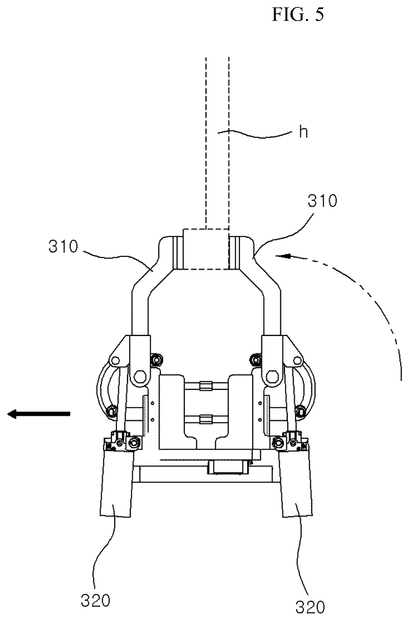

As a result, as shown in FIG. 5, the rear clamper 310 also rotates upward, making close contact with the rear side of the hanger arm (h).

This ensures that both the front and rear sides of the hanger arm (h) are securely held by the pair of clampers 310, coupling the moving member 100 with the transport carrier C at the home position P1.

When the coupled moving member 100 reaches the return position P2, the interlock release switch 350 is contacted by the moving member 100.

This contact signal causes the pair of clampers 310 to rotate downward to their original positions, thereby releasing the coupling between the moving member 100 and the transport carrier C.

The coupling interlocking unit 300 may also be configured to adjust the holding pressure of the clamper 310 depending on the embodiment.

For example, a pair of adjustment dies 360, whose interval can be adjusted by a turnbuckle 361, may be further included. The pair of clampers 310 and clamping cylinders 320 may be supported by the pair of adjustment dies 360.

The return driving unit 400 provides a backward movement force to the moving member 100 so that it can return from the return position P2 to the home position P1.

The return driving unit 400 can be configured in various ways and may include, for example, a timing belt 410 and a drive motor 420.

The timing belt 410 is coupled with the moving member 100 and is supported by pulleys at both ends. It may be installed in the central portion of the base frame 200 in the front-rear direction.

The drive motor 420 may be coupled to the front pulley of the timing belt 410 in a manner that allows for the controlled transmission of power.

With this configuration, when the moving member 100 moves forward, the timing belt 410 operates passively due to the movement of the moving member 100. In the opposite case, the drive motor 420 actively moves the moving member 100 backward by applying driving power to the timing belt 410.

The tracking information providing unit is a control unit for a robot arm used for tire mounting, providing tracking-related information.

That is, the tracking information providing unit measures displacement information according to the forward movement of the moving member 100 and provides this information to the control unit of the robot arm for tracking control.

Here, the displacement information based on the forward movement of the moving member 100 corresponds to the displacement information of the vehicle body V loaded on the transport carrier C.

Therefore, the control unit of the robot arm can track the moving vehicle body and control the robot arm for tire mounting based on the provided displacement information.

The tracking information providing unit may include, for example, an encoder 510 and multiple passage detection switches 520a, 520b, 520c, 520d.

The encoder 510 provides the displacement information of the moving member 100 to the control unit of the robot arm.

For example, the encoder 510 may be installed on the rear pulley of the timing belt 410. It measures the rotation angle of the rear pulley, which rotates passively due to the forward movement of the moving member 100, and provides displacement information about the moving member 100.

The multiple passage detection switches 520a, 520b, 520c, 520d provide control information to the robot arm's control unit to start and stop the tracking operation.

The passage detection switches 520a, 520b, 520c, 520d may be arranged at regular intervals along the forward movement path of the moving member 100, sequentially contacting the moving member 100 as it advances and providing respective contact information.

For example, the multiple passage detection switches 520a, 520b, 520c, 520d may include:

A first passage detection switch 520a, providing start information for the tracking operation for the front tire mounting.

A second passage detection switch 520b, positioned at a predetermined distance ahead of the first switch, providing end information for the tracking operation for the front tire mounting.

A third passage detection switch 520c, positioned at a predetermined distance ahead of the second switch, providing start information for the tracking operation for the rear tire mounting.

A fourth passage detection switch 520d, positioned at a predetermined distance ahead of the third switch, providing end information for the tracking operation for the rear tire mounting.

The disk angle information providing unit 600 measures the angle of the wheel disk (D) and provides this information to the control unit of the robot arm.

Since the front wheel disk is subject to steering, unlike the rear wheel disk, it may not be positioned straight in the front-rear direction but rather at a certain tilted angle.

Therefore, to automatically mount a tire on the front wheel disk, the robot arm must precisely adjust its docking angle to align with the tilted angle of the wheel disk.

Accordingly, the disk angle information providing unit 600 measures the angle of the front wheel disk and provides the angle information to the control unit of the robot arm. The control unit then adjusts the approach angle of the robot arm based on this information, ensuring precise tire mounting on the front wheel disk.

The disk angle information providing unit 600 may be positioned at both left and right ends of the moving member 100 in front of the coupling interlocking unit 300.

Thus, when the moving member 100 is coupled to the transport carrier C, the disk angle information providing unit 600 is located in a position corresponding to the front wheel disk (D) of the vehicle body loaded on the transport carrier C.

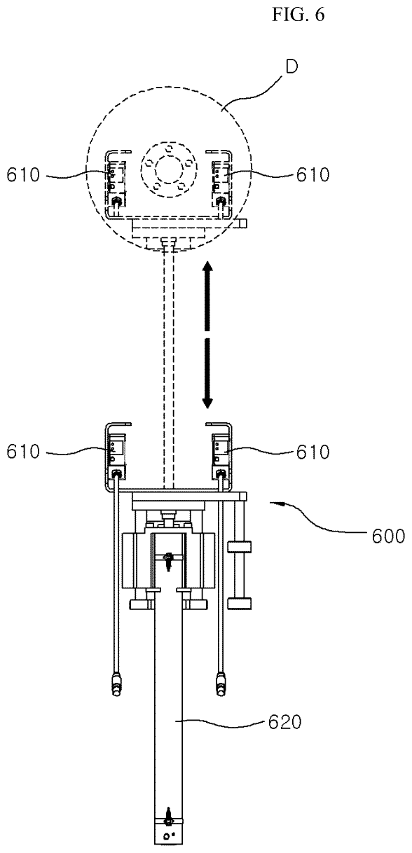

As illustrated in FIG. 6, the disk angle information providing unit 600 may include a measurement sensor 610, a lifting drive unit 620, and an angle calculation unit (not shown in the drawing).

The measurement sensor 610 may include a pair of sensors that are spaced apart by a predetermined distance (d) in the front-rear direction.

These paired measurement sensors 610 face the wheel disk D and measure the distances (L1, L2) to two specific points on the wheel disk D.

For example, the paired measurement sensors 610 may be laser sensors that emit laser beams to two specific points on the wheel disk D and measure the distance by calculating the time taken for the reflected laser beams to return.

If the wheel disk is positioned straight without any lateral tilt, the distance values (L1, L2) measured by the paired measurement sensors 610 will be equal (L1=L2).

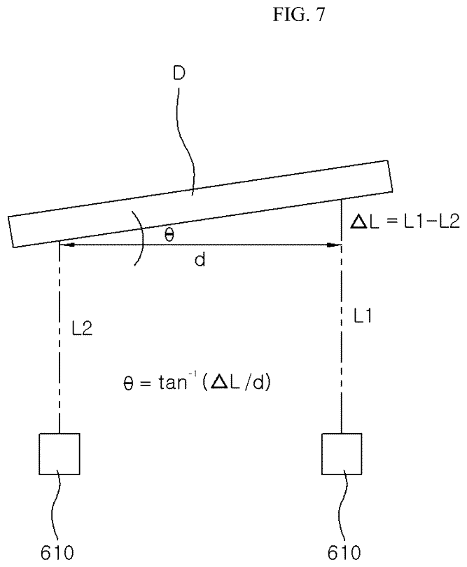

However, as illustrated in FIG. 7, if the wheel disk is tilted at a certain angle to the left or right, the measured distances (L1, L2) will differ (L1≠L2).

The lifting drive unit 620 allows the paired measurement sensors 610 to selectively position themselves in front of the wheel disk and face it for measurement.

That is, the measurement sensors 610 are lifted by the lifting drive unit 620 to face the wheel disk and measure the distances to two specific points. After measurement, they are lowered so as not to obstruct the path of the robot arm as it approaches the wheel disk.

The angle calculation unit calculates the tilt angle (θ) of the wheel disk based on the measured distance values (L1, L2) and the spacing D between the paired measurement sensors 610.

As illustrated in FIG. 7, the tilt angle (θ) of the wheel disk is calculated using the following formula based on the difference in measured distances (ΔL=L1−L2) and the sensor spacing (d):

$$θ = {tan}^{- 1} ( Δ L / d )$$

The calculated wheel disk angle information is then provided to the control unit of the robot arm.

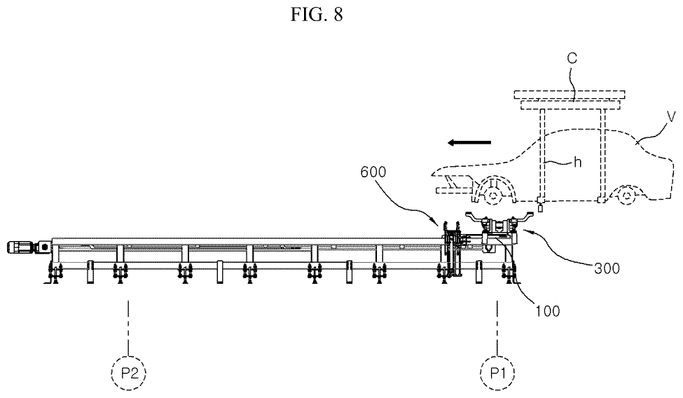

With the structural configuration of the present invention described above, the following explains the operational process with reference to FIGS. 8 to 11.

First, as illustrated in FIG. 8, the moving member 100 is positioned at the home position P1, while the transport carrier C carrying the vehicle body V advances forward.

As the transport carrier C approaches the home position P1, the hanger arm (h) contacts the first interlocking switch 330, causing the front clamper 310 to rotate upward and position itself in front of the hanger arm (h).

Then, as the hanger arm (h) closely contacts the front clamper 310, it also contacts the second interlocking switch 340, which in turn causes the rear clamper 310 to rotate upward.

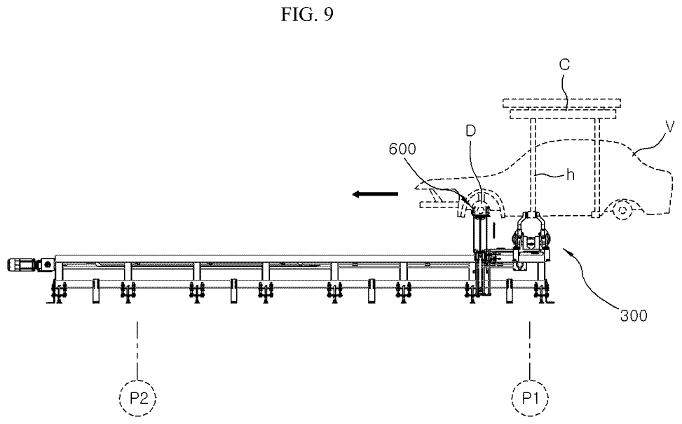

As illustrated in FIG. 9, the pair of clampers 310 hold the hanger arm (h), coupling the moving member 100 with the transport carrier C. This initiates the synchronized forward movement of the moving member 100 with the transport carrier C.

At this point, the pair of measurement sensors 610 rise to a height that allows them to face the front wheel disk D.

The sensors then emit laser beams to two specific points on the front wheel disk D to measure distances and provide angle information to the control unit of the robot arm.

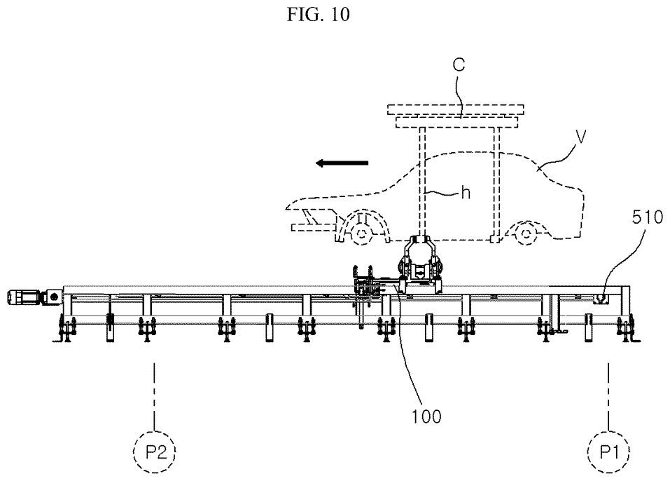

Meanwhile, as illustrated in FIG. 10, as the coupled moving member 100 moves forward, the timing belt 410 also operates passively, and the encoder 510 provides displacement information of the moving member 100 to the control unit of the robot arm.

This displacement information of the moving member 100 is continuously provided throughout the forward movement process.

Additionally, multiple passage detection switches 520a, 520b, 520c, 520dsequentially contact the moving member 100 during its forward movement, providing corresponding contact information to the control unit of the robot arm. Based on this contact information, the tracking operation for tire mounting is controlled.

Specifically, the robot arm starts the tracking operation upon receiving the contact information from the first passage detection switch 520a. Then, it is controlled based on the displacement information provided by the encoder 510 and the angle information provided by the disk angle information providing unit 600, enabling it to mount a tire onto the front wheel disk. Once the second passage detection switch 520b provides contact information, the tracking operation for the front wheel disk mounting is terminated.

Subsequently, upon receiving the contact information from the third passage detection switch 520c, the robot arm starts another tracking operation. It continues to be controlled based on the displacement information provided by the encoder 510, enabling it to mount a tire onto the rear wheel disk. The tracking operation for the rear wheel disk mounting is completed when the fourth passage detection switch 520d provides contact information.

After passing through the passage detection switches, the moving member 100 eventually reaches the return position P2, where it contacts the interlock release switch 350. This causes the coupling between the moving member 100 and the transport carrier C to be released, and then the return driving unit 400 is activated.

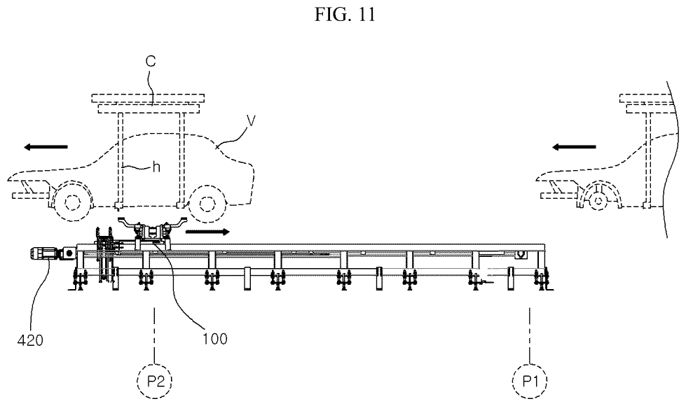

As illustrated in FIG. 11, once the transport carrier C continues to move forward, the moving member 100 independently moves backward, returning to its original home position P1, thereby completing one operational cycle.

This process is then repeated for the subsequent vehicle body entering the home position P1, following the same sequence as described above.

The above has been a detailed description of the preferred embodiment of the present invention. However, the technical scope of the present invention is not limited to the embodiments and drawings described above. Modifications or equivalent configurations made by those skilled in the art without departing from the technical spirit of the present invention shall also be considered within the technical scope of the invention.

What is claimed is:

1. A robot control information providing device for automatic tire mounting, comprising:
a moving member configured to move along a transport direction of a vehicle body;
a coupling interlocking unit configured to couple the moving member with a transport carrier, which transports the vehicle body for tire mounting, enabling the moving member to advance in synchronization with the transport carrier;
a return driving unit configured to provide a movement force to the moving member to move the moving member backward to its original position; and
a tracking information providing unit configured to provide displacement information of a moving member's forward movement.

2. The robot control information providing device according to claim 1, further comprising:
a disk angle information providing unit configured to measure an angle of a front wheel disk of the vehicle body.

3. The robot control information providing device according to claim 2, wherein the disk angle information providing unit comprises:
a pair of measurement sensors spaced apart from each other at a predetermined interval and configured to measure a distance to two points on the front wheel disk; and
an angle calculation unit configured to calculate the angle of the front wheel disk based on a difference in the measured distances from the pair of measurement sensors and the interval between them.

4. The robot control information providing device according to claim 3, wherein the disk angle information providing unit further comprises:
a lifting drive unit configured to selectively lift the pair of measurement sensors so that the pair of measurement sensors are positioned in front of the front wheel disk and face the front wheel disk.

5. The robot control information providing device according to claim 1, wherein the coupling interlocking unit comprises:
a pair of front and rear clampers configured to rotate to either hold a hanger arm of the transport carrier by positioning themselves in its movement path or release a holding of the hanger arm by moving out of the path; and
a pair of front and rear clamping cylinders configured to apply rotational force to each of the pair of front and rear clampers.

6. The robot control information providing device according to claim 5, wherein the coupling interlocking unit further comprises:
a first interlocking switch positioned at a rear of the rear clamper; and
a second interlocking switch positioned at an end of the front clamper,
wherein the front clamper is configured to rotate to position itself in the movement path of the hanger arm when the hanger arm contacts the first interlocking switch, and
the rear clamper is configured to rotate to hold the hanger arm together with the front clamper when the hanger arm contacts the second interlocking switch after making contact with the front clamper.

7. The robot control information providing device according to claim 1, wherein the tracking information providing unit comprises:
an encoder configured to measure the displacement information of the moving member's forward movement and provide the displacement information; and
a plurality of passage detection switches arranged along the forward movement path of the moving member and configured for sequentially contacting the moving member.

8. A device for tire mounting, the device comprising:
a transport carrier configured to transport a body of a vehicle on which a tire is to be mounted;
the robot configured to automatically mount the tire on the vehicle and having the arm and a control unit configured to control the arm; and
the robot control information providing device of claim 1,
wherein the robot control tracking information providing unit is configured to provide displacement information of the moving member's forward movement to the control unit so that the control unit tracks a movement of the vehicle body and controls the arm, based on the provided displacement information

9. The device of claim 8, wherein the tracking information providing unit comprises:
an encoder configured to measure the displacement information of the moving member's forward movement and provide the displacement information to the control unit; and
a plurality of passage detection switches arranged along the forward movement path of the moving member and configured for sequentially contacting the moving member and providing respective contact information to the control unit.
